(19) United States
(12) Patent Application Publication
(10) Pub. No.: US 2025/0150339 A1
(43) Pub. Date: May 8, 2025

(54) UTILIZING APPLICATION CONFIGURATIONS AND STATE FOR NETWORK MANAGEMENT

(71) Applicant: Cisco Technology, Inc., San Jose, CA (US)

(72) Inventors: Alberto Rodriguez-Natal, Leon (ES); Saswat Praharaj, Pleasanton, CA (US); Pradeep Kumar Kathail, Los Altos, CA (US); Fabio R. Maino, Palo Alto, CA (US); Lorand Jakab, Gheorghieni (RO); Ram Dular Singh, Cupertino, CA (US); Vivek Agarwal, Campbell, CA (US)

(21) Appl. No.: 18/940,829

(22) Filed: Nov. 7, 2024

Related U.S. Application Data
(60) Provisional application No. 63/596,950, filed on Nov. 7, 2023.

(51) Int. Cl. H04L 41/0816; H04L 41/085

(52) U.S. Cl. CPC H04L 41/0816; H04L 41/085

(57) ABSTRACT

Techniques for an application watcher system that includes a plurality of watchers that obtain various types of application configurations and/or state data which is used to make networking decisions and drive networking operations. The watchers of the application watcher system may each be configured to communicate with an application orchestration system that manages the application and obtain different types of application configurations and/or state data. In some instances, the application watcher system may run on a network orchestrator of the network, or be in communication with the network orchestrator, and provide application configurations and/or state data to the network orchestrator to make networking decisions.

### RELATED APPLICATIONS

This application claims priority to U.S. Provisional Application No. 63/596,950, filed on Nov. 7, 2023, the entire contents of which is incorporated herein by reference in its entirety and for all purposes.

### TECHNICAL FIELD

The present disclosure relates generally to techniques for, among other things, performing network management operations for traffic communicate with an application based on application configurations or state received from an application orchestration system.

### BACKGROUND

Rather than storing data or hosting applications locally on computing devices, it is becoming overwhelmingly popular to store data or host applications on remote computing resources, such as public cloud networks, private computing networks, on-premises networks, or enterprise networks. It follows that the number of network flows and amount of network traffic being communicated across various networks, such as Software-Defined Wide Area Networks (SD-WAN) (e.g., the Internet, cellular networks, etc.) has also greatly increased. Some applications or services have become incredibly popular such that many users located across large geographic areas desire to access the applications or services. Accordingly, various application orchestration systems have emerged to organize instances of an application into multi-cluster architecture that are run in different geographic regions and data centers.

These modernized distributed applications require efficient network connectivity. However, it's becoming more challenging for network operators to adequately understand the needs of these composable microservice applications. Moreover, tackling the dynamic nature of these applications poses an additional challenge since their requirements can quickly change overtime. This lack of insight into the behavior of applications can result in degraded performance when network orchestrators (e.g., SD-WAN controllers) attempt to handle and route network traffic across networks and between users and applications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture in which an application watcher system obtains application configurations and state data from an application orchestration system, and uses that data for determining network operations.

FIG. 2 is a flow diagram illustrating example operations that may be performed be respective entities to use application configurations and state data to determine network operations.

FIG. 3 is an example diagram of application configurations and state data obtained by an application watcher system.

FIG. 4 is an example architecture diagram in which an egress watcher of an application watcher system automates traffic optimizations for egress traffic of an application orchestration system that is being sent over a network to a remote service.

FIG. 5 is an example architecture diagram in which a replica watcher of an application watcher system track compute capacity of an application to dynamically allocate bandwidth for data flows associated with the application.

FIG. 6 is an example architecture diagram in which an ingress watcher of an application watcher system automates traffic optimizations for ingress traffic of an application orchestration system that is being sent over a network to an application.

FIG. 7 is a flow diagram illustrating an example method for multiple application watchers to obtain application configuration or state data that is used to determine network operations.

FIG. 8 is a flow diagram illustrating an example method for an application watcher to obtain application configuration or state data that is used to determine network operation.

FIG. 9 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes various technologies for an application orchestration system to execute an application watcher system that collects application configuration and state information and uses that information to determine network actions or operations. By way of example, and not limitation, the techniques described herein may include a first method that includes executing a plurality of watchers where each of the plurality of watchers are configured to obtain different types of application configuration or state data from an application managed by an application orchestration system. The first method may include obtaining, using a first watcher, a first type of application configuration or state data from the application, and obtaining, using a second watcher, a second type of application configuration or state data from the application. Additionally, the first method may include determining, using the first type of application configuration or state data, a first network operation to perform in the network, and determining, using the second type of application configuration or state data, a second network operation to perform in the network. Further, the first method may include causing the first network operation and the second network operation to be performed in the network such that a configuration and/or state of the network is modified.

In some instances, a second method may include executing a plurality of watchers of the application watcher system where each of the plurality of watchers are configured to obtain different types of application configuration or state data from an application managed by an application orchestration system. Further, the second method may include obtaining, using a watcher, a type of application configuration or state data from the application, and determining, using the type of application configuration or state data, a network operation to perform in the network. Additionally, the second method may include causing the network operation to be performed in the network such that a configuration and/or state of the network is modified.

Additionally, the techniques of the first and second methods, and otherwise described herein, may be performed as a device and/or by a system having non-transitory computer-readable media storing computer-executable instructions that, when executed by one or more processors, performs the techniques described above and herein.

### Example Embodiments

This disclosure describes an application watcher system that includes a plurality of watchers that obtain various types of application configurations and/or state data which is used to make networking decisions and drive networking operations. As noted above, applications and services are increasingly being hosted on remote computing resources, such as public clouds and enterprise networks. This results in an increase in network traffic over various networks that users utilize to access these applications and services (e.g., the Internet, campus networks, cellular networks, etc.). Traditionally, network orchestrators (also referred to as “network controllers”) of these networks have had limited or no visibility into the applications for which the networks transport network traffic. This lack of insight into the behavior of applications can result in degraded performance when network orchestrators (e.g., SD-WAN controllers) attempt to handle and route network traffic across networks and between users and applications.

According to the techniques described herein, the watchers of the application watcher system may each be configured to communicate with an application orchestration system that manages the application and obtain different types of application configurations and/or state data. In some instances, the application watcher system may run on a network orchestrator of the network, or be in communication with the network orchestrator, and provide application configurations and/or state data to the network orchestrator to make networking decisions. In various instances, the watchers of the application watcher system may run on the application orchestration system itself, and provide the configuration and/or state data to the network orchestrator.

An egress watcher may be configured to obtain an egress traffic definition that includes various information that may be useful by the network orchestrator to make routing or other policy/networking decisions. For instance, the egress watcher may extract egress traffic information from the application orchestration system, such as destination IP address, port, network 5-tuple, hostname, or Uniform Resource Locator (URL), and make that information available to network infrastructure or a controller of the network (e.g., SDN controller, SD-WAN controller, etc.) so that the egress traffic definition can be used to establish, monitor, and/or select different paths for the egress traffic to traverse towards the remote services. Similarly, an ingress watcher may be configured to obtain an ingress traffic definition that includes various information that may be useful by the network orchestrator to make routing or other policy/networking decisions. For instance, the ingress watcher may extract ingress traffic information from the application orchestration system for traffic that is expected or often received at the application orchestration system, such as IP address, port, network 5-tuple, hostname, or (URL), and make this ingress information available the network orchestrator. The network orchestrator can then make traffic decisions for recognized ingress traffic, such as establishing, monitoring, and/or selecting different paths for the ingress traffic to traverse towards the remote services.

Other types of watchers may be employed, such as an encryption watcher and a replica watcher. The encryption watcher may be configured to extract application configuration or state data including an encryption policy for the application indicating that the traffic requires encryption. This information may be passed to the network orchestrator that determine if application-to-application traffic, user-to-application traffic, application related traffic, etc., needs to be encrypted is in fact encrypted, and if not, encrypt the traffic as it passes through the network. The replica watcher may be configured to obtain application state data that includes replica data indicative of a change in an amount of computing resources (e.g., increase or decrease), and/or the number of instances of the application (i.e., replicas) that are allocated to host the application, and provide that information to the network orchestrator. The network orchestrator may then increase or decrease the amount of bandwidth of the physical underlay of the network for the application to account for the application consumption changes.

Another type of watcher provided by the application watcher system is a capacity watcher. The application orchestration system may manage different instances of the application at multiple sites (e.g., data centers) that are remote from each other. The capacity watcher may be configured to obtain application state data that indicates available amounts of capacity at the different sites, and provide the capacity data to the network orchestrator. The network orchestrator may then route traffic to one of the sites based on the site having more available capacity as compared to other sites.

As described herein, an “application orchestration system” may be any type of application orchestration system or container orchestration platform (e.g., Kubernetes, Docker Swarm, Apache Mesos, OpenStack, Proxmox, any public cloud, etc.) that is capable of explicitly defining configuration for application traffic and application behavior. In some examples, the defined configurations may be a part of the general configuration of the application orchestration system itself (e.g., part of some network policies in Kubernetes), can be an ad-hoc configuration in place to handle traffic (e.g., in-house solutions), can be part of a component running on the application orchestration system that is capable of handling the egress traffic (e.g., a service mesh, such as Istio, where explicit egress policies can be defined), and/or the like.

In some examples, the watchers may be capable of automatically extracting the application configurations and/or states from the application orchestration system, and make that information available to network infrastructure or the network orchestrator of the network (e.g., SDN controller, SD-WAN controller, etc.) so that the application configurations and/or state can be used to make networking decisions with respect to traffic associated with the application. In one example, an agent (e.g., SD-WAN agent, Kubernetes controller or operator, etc.) may be ran on the infrastructure of the application orchestration system, and the agent may monitor and/or retrieve egress information data and pass it on to the watchers.

By way of example, and not limitation, the watchers may obtain the application configurations and/or state data using various mechanisms, such as Application Programming Interfaces (APIs), direction connections, control-plane connections, etc. In examples, the watchers may obtain the application configurations and/or state data may be received from an agent that is running on resources of the application orchestration system. In examples, the agent may be configured to monitor and/or retrieve application configurations and/or state data on behalf of the application watcher system, as well as configured to forward the application configurations and/or state data on to the application watcher system. As an additional, or alternative, example, the application configurations and/or state data may be received by the application watcher system via a connection with the application orchestration system. For instance, the application watcher system may establish a connection with the application orchestration system and obtain, via the connection, the application configurations and/or state data from the application orchestration system. In some examples, the application configurations and/or state data may be obtained or otherwise received from an external database, a service registry, or the like where this information may be stored.

The technologies disclosed herein enable several advantages in computer-related technology to be achieved. For example, the technologies described herein enable a network (e.g., a SD-WAN) to automatically consume application configurations and/or state data from application orchestration systems (e.g., Kubernetes) and use the application configurations and/or state data to configure traffic optimizations for application traffic. By configuring these traffic optimizations, application traffic can be sent from application orchestration systems to various users or remote services via networking optimizations that are specifically tailored or selected to meet the demands of the traffic. In some instances, certain flows may be given more bandwidth, reduced latency, encryption, additional computing resources, more throughput, or the like in order to meet optimization requirements. Additionally, in some instances, by providing the network with application configurations and/or state data from an application orchestration system, the network may more efficiently allocate its resources. Other improvements in computer-related technology will be readily apparent to those having ordinary skill in the art.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

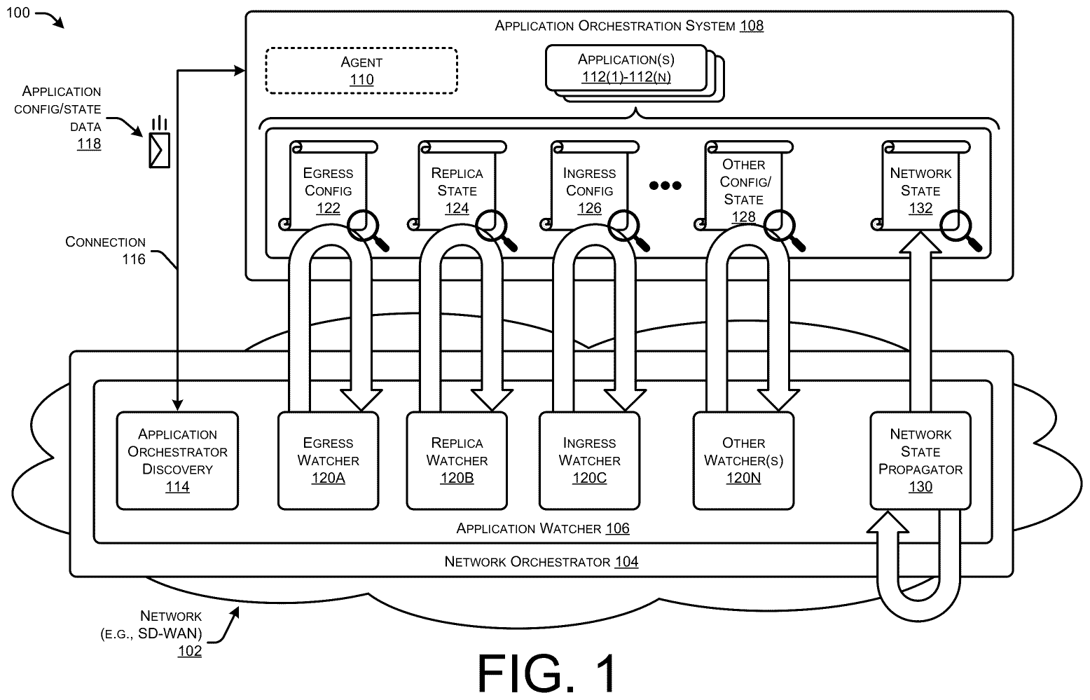

FIG. 1 illustrates an example architecture 100 in which an application watcher system obtains application configurations and state data from an application orchestration system, and uses that data for determining network operations.

The architecture 100 may include a network 102 that is disposed between an application orchestration system 108 and various entities such as users, remote services, etc. In some examples, a network orchestrator 104 of the network 102 may receive application configuration or state data 118 associated with the application orchestration system 108. In some examples, the application orchestration system 108 may be a platform that automates the deployment, scaling, and management of applications 112, such as containerized applications 112. The application orchestration system 108 may orchestrate the deployment and operation of applications 112 in containers (or other virtual environments, such as virtual machines), abstracting away many of the complexities associated with container management.

The application configuration or state data 118 may, in some examples, comprise data indicating various configurations or states of one or more application(s) 112(1)-112(N) of the application orchestration system 108. The application configuration data is generally the set of parameters, settings, or values that define how the application 112 behaves, interacts with other services, or is deployed within a cluster. The application configuration data may include, but is not limited to, the unique name of the application 112, the namespace where the application 112 resides, the type of service (e.g., ClusterIP, NodePort, LoadBalancer, ExternalName) which determines how the service is exposed and accessed, the port on which the service is exposed and listens for traffic, the target port on the container that the service forwards traffic to, the selector or labels used to determine which pods the service targets and routes traffic to, the ClusterIP or the internal IP address for the service within the cluster, and if applicable, an external IP or the external IP address for accessing the service. The application configurations may further include environment variables or Configuration values or secrets passed to containers running within the service (e.g., database URLs, authentication tokens, or API keys), health check configuration such as the liveness and readiness probes that determine if the service or its associated pods are functioning correctly and can receive traffic, resource limits/request or the CPU, memory, and storage limits and requests set for the service, or for the pods behind the service, ensuring appropriate resource allocation, and/or TLS/SSL settings or the configuration for secure communication, such as specifying SSL certificates or encryption methods for sensitive services.

The application state data generally refers to the data or information that is indicates current, and dynamic, settings of the application 112 that is used for restarts, scaling, or failures. Configurations are generally static, whereas state is generally dynamic. For a Kubernetes application, state data can refer to any data that is tied to the application's state. In some instances, the replica state refers to the desired and actual state of the number of replicas (or instances) of a pod running in the cluster. The application orchestration system 108 ensures that the desired number of replicas are always running to maintain the health, availability, and scalability of applications. If there are discrepancies between the desired and actual state, the application orchestration system 108 automatically takes corrective action to match the desired state.

In examples, the network 102 may be a software-defined wide area network (SD-WAN). Although many of the examples described herein are with respect to SD-WAN, other types of network configurations are possible in addition to, or alternatively to, an SD-WAN. For instance, the network 102 may also include a multiprotocol label switching (MPLS) network, a 4G or 5G network, a broadband internet network, a dedicated internet network, or any computer network.

In examples, the network orchestrator 104 may be a software-defined networking (SDN) controller that monitors, probes, establishes, etc. flows over the network 102. In some instances, the network orchestrator 104 may be an application in the network 102 architecture that manages flow control for improved network management and application performance. In some examples, the network orchestrator 104 may run on a server and use protocols to tell switches or routers of the network 102 (e.g., the edge nodes other devices of the network fabric) where to send packets (e.g., ingress traffic, egress traffic, etc.). In some examples, the network orchestrator 104 may direct traffic according to one or more forwarding policies defined by a network operator, thereby minimizing manual configurations for individual network devices of the network 102 fabric.

The application watcher 106 may be a package composed by different modules/components. This package could be instantiated inside the network orchestrator 104 itself or being an independent package that interacts with the network orchestrator 104 via APIs. The application watcher 106 could also be deployed inside an application orchestration system 108 (with which might interact or interact with another application orchestrator). FIG. 1 represents the operation of the different components of the application watcher 106, and while FIG. 1 shows the application watcher 106 inside the network orchestrator 104, this is only one possibility as discussed herein.

As illustrated, an application orchestrator discovery 114 component of the application watcher 106 may facilitate with collecting information about application orchestration systems 108 and provide access to the application information they contain. The application orchestrator discovery 114 component could collect information automatically from cloud sources (e.g., leveraging the access to cloud resources available or provisioned in the network orchestrator 104) or it could be able to expose an interface/UI for network operators to provide details about the application orchestration system 108.

In examples, how the application orchestrator discovery 114 component receives the application configuration or state data 118 associated with the applications 112 may vary depending upon implementation. In some examples, the application orchestrator discovery 114 component may establish a connection 116 with the application orchestration system 108. Via the connection 116, the application orchestrator discovery 114 component may obtain the application configuration or state data 118 on demand from the application orchestration system 108. Additionally, or alternatively, in some examples, an agent 110 may be running on the application orchestration system 108, and the agent 110 may be configured to monitor and/or retrieve application configuration or state data 118 data on behalf of the application orchestrator discovery 114 component, as well as configured to forward the application configuration or state data 118 to the application orchestrator discovery 114 component. As just an example, if a new egress traffic configuration is detected by the agent 110 (e.g., a new application 112 is spun up), if a change in an egress traffic configuration is detected by the agent 110, or in other cases, the agent 110 may forward the application configuration or state data 118 associated with that egress traffic configuration to the application orchestrator discovery 114 component.

The application watcher 106 may include a collection of watchers 120 that monitor and collect information about different application configurations or states present in the application orchestration system 108 (e.g., information about external services the applications communicate with, number of replicas of a given application 112, applications 112 that are being exposed to receive incoming traffic, etc.). The information collected is then used to drive actions on the network 102 (e.g., external service information can drive SaaS optimization, number of replicas can serve to allocated bandwidth, ingress information can generate different network policies, etc.).

As an example, an egress watcher 120A may be configured to obtain egress configurations 122 that includes various information that may be useful by the network orchestrator 104 to make routing or other policy/networking decisions. For instance, the egress watcher 120A may extract egress traffic information from the application orchestration system 108, such as destination IP address, port, network 5-tuple, hostname, or Uniform Resource Locator (URL), and make that information available to the network orchestrator 104 so that the egress configurations 122 can be used to establish, monitor, and/or select different paths for egress traffic from the applications 112 to traverse towards the remote devices or services.

A replica watcher 120B may be configured to obtain replica state data that is indicative of a change in an amount of computing resources (e.g., increase or decrease) that are allocated to host the application 112, and provide that information to the network orchestrator 104. The network orchestrator 104 may then increase or decrease the amount of bandwidth of the physical underlay of the network 102 for the application 112 to account for the application consumption changes.

Further, an ingress watcher 120C may be configured to obtain ingress configurations 126 that include various information that may be useful by the network orchestrator 104 to make routing or other policy/networking decisions. For instance, the ingress watcher 120C may extract ingress traffic information from the application orchestration system 108 for traffic that is expected or often received at the application orchestration system 108, such as IP address, port, network 5-tuple, hostname, or (URL), and make this ingress information available the network orchestrator 104. The network orchestrator 104 can then make traffic decisions for recognized ingress traffic, such as establishing, monitoring, and/or selecting different paths for the ingress traffic to traverse towards the remote services.

Other watchers 120N may be employed, such as an encryption watcher and a capacity watcher that extract other configurations and/or state 128 from the application orchestration system 108. The encryption watcher may be configured to extract application configuration or state data including an encryption policy for the application indicating that the traffic requires encryption. This information may be passed to the network orchestrator 104 that determines if application-to-application traffic that needs to be encrypted is in fact encrypted, and if not, encrypt the traffic as it passes through the network. Another type of watcher provided by the application watcher 106 is a capacity watcher. The application orchestration system 108 may manage different instances of the application at multiple sites (e.g., data centers) that are remote from each other. The capacity watcher may be configured to obtain application state data that indicates available amounts of capacity at the different sites, and provide the capacity data to the network orchestrator 104. The network orchestrator 104 may then route traffic to one of the sites based on the site having more available capacity as compared to other sites.

A network state propagator 130 that can gather network state 132 and make it available at the application orchestration system 108 level. This network state 132 could be related with the network actions taken as a consequence of the watchers 120 propagating application state and configurations to the network orchestrator 104. It could also be network state 132 relevant to the different application configuration/state collected by the watchers 120. The network state 132 exposed at the application orchestration system 108 could be represented by its own configuration/state objects in the application orchestration system 108, or could be attached to existing config/state in the application orchestration system 108 (particularly when the existing app config/state is being fetched by the different watchers 120). Note that FIG. 1 shows the network state 132 as its own object in the application orchestration system 108, but that is not always going to be the case as discussed.

In some examples, the application orchestration system 108 may be any type of application orchestration system or container orchestration platform (e.g., Kubernetes, Docker Swarm, Apache Mesos, etc.) that is capable of explicitly defining application configurations and managing application state. In some examples, this defined configurations may be a part of the general configuration of the application orchestration system 108 itself (e.g., part of some network policies in Kubernetes), can be an ad-hoc configuration, can be part of a component running on the application orchestration system 108, and/or the like. In some examples, the application orchestration system 108 infrastructure may be running at an enterprise site, a cloud-based data center, an enterprise data center, or the like.

In examples, the applications 112 may be communicated traffic with remote service(s) that may be any type of remote service or application that is being utilized by the one or more application(s) 112 and/or the application orchestration system 108. For examples, the remote service(s) may include, among other things, software as a service (SaaS) workloads, application programming interface (API) services, remote storage or database solutions (e.g., key-value stores), middleware services, monolithic services, or the like.

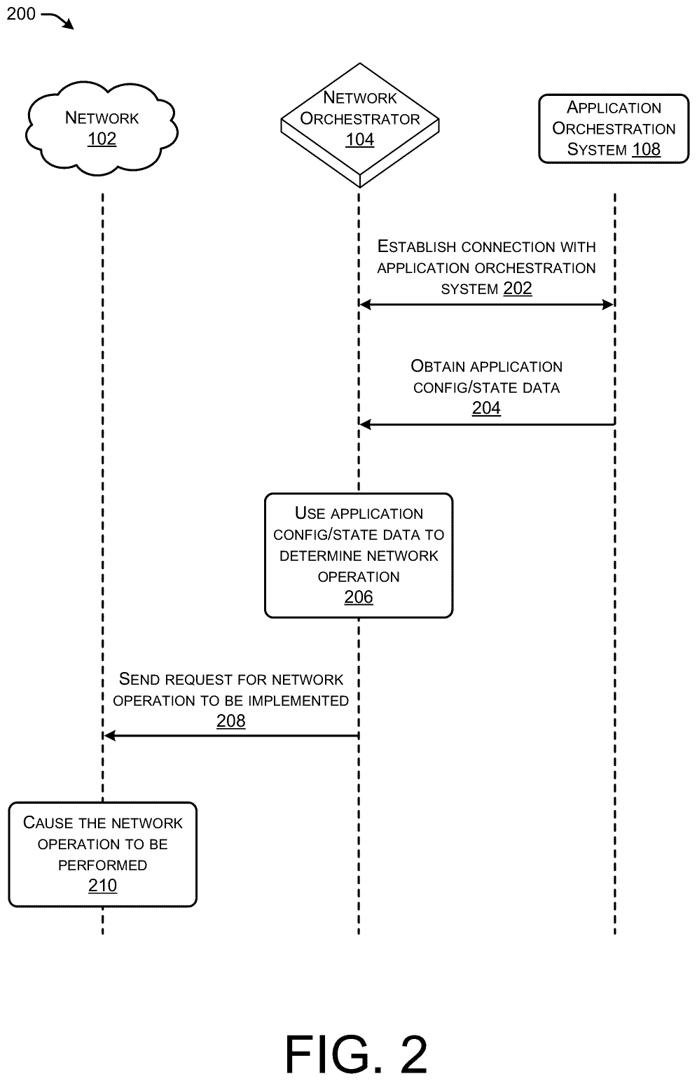

FIG. 2 is a flow diagram illustrating example operations that may be performed be respective entities to use application configurations and state data to determine network operations.

As 202, the network orchestrator 104 and application orchestration system 108 may establish a connection 116 with each other. The connection 116 may allow the application watcher 106 to monitor, obtain, create, modify, etc. application configurations and/or state data 118 associated with applications 112 hosted on the application orchestration system 108.

At 204, the network orchestrator 104 may obtain application configurations and/or state data 118 from the application orchestration system 108. For instance, one or more watchers 120 may obtain configurations and/or state data from the application orchestration system 108.

At 206, the network orchestrator 104 may use the application configurations and/or state data 118 to determine a network operation to perform. For instance, the network orchestrator may determine to make routing decisions, encryption decisions, quality of service or priority decisions for application traffic, and so forth.

At 208, the network orchestrator 104 may send a request for the network operation to be implemented 208. For instance, the network orchestrator 104 may send a command to one or more network devices to route traffic using a particular route, encrypt the traffic as it is sent through the network 102, provide a particular quality of service for the traffic based on the application, and so forth. At 210, the network device(s) may cause the network operation to be performed.

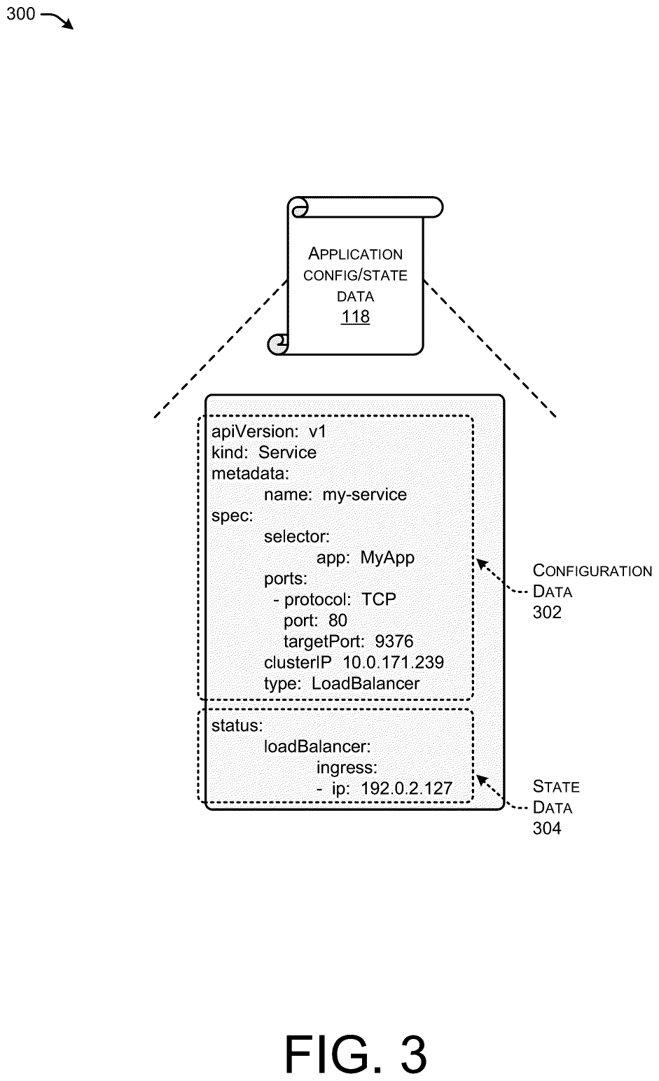

FIG. 3 is an example diagram 300 of application configurations and state data 118 obtained by an application watcher 106. As shown, the application configurations and state data 118 includes configuration data 302 and state data 304. The application configurations and state data 118 may be expressed in YAML (or another language) and may be an example of a Kubernetes Service resource.

The configuration data 302 may include the apiVersion that specifies the API version used to interact with the applications 112, the kind tells application orchestration system 108 what type of resource is being defined, the metadata contains additional information about the resource, the name field specifies the name of the service, and the spec defines the desired state of the service (e.g., application 112). As shown, the spec may include the selector, ports, protocol, and target port (the port on the selected pods that the service will forward traffic to), the cluster IP (e.g., a fixed internal IP address assigned to the service within the cluster), and a type (e.g., LoadBalancer indicates that the service/application will be exposed externally via a cloud provider's load balancer, and this allows traffic to reach the service/application from outside the cluster).

The state data 304 may include the status which contains the current state of the resource. The status may include the loadBalancer section that contains the details about the load balancer for the service, and the ingress section that shows the external IP address (192.0.2.127) assigned to the load balancer, which clients can use to access the service from outside the cluster.

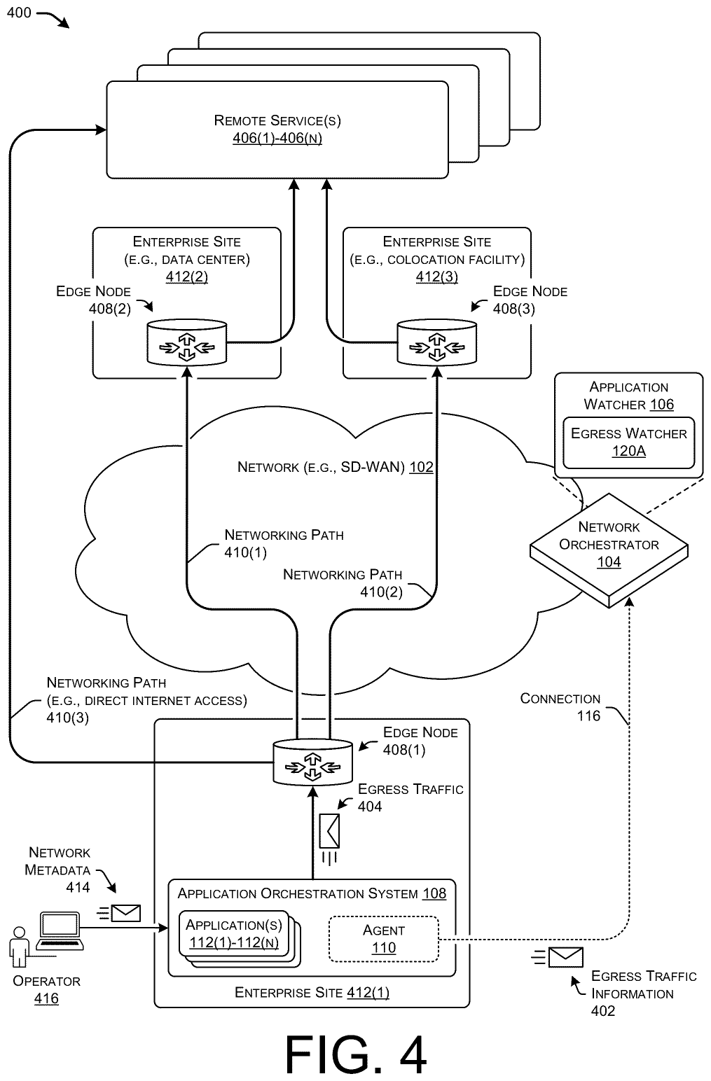

FIG. 4 is an example architecture 400 in which an egress watcher 120A of an application watcher 106 automates traffic optimizations for egress traffic of an application orchestration system 108 that is being sent over a network to a remote service.

The architecture 400 may include a network 102 that is disposed between an application orchestration system 108 and one or more remote service(s) 406(1)-406(N) (where N can represent any number). In some examples, a network orchestrator 104 of the network 102 may receive egress traffic information 402 (e.g., egress configuration 122) associated with the application orchestration system 108. Some of the techniques are described herein as being performed by the network orchestrator, 104, but it should be understood that some or all of those techniques may be performed with or by the application watcher 106 and the egress watcher 120A. The egress traffic information 402 may, in some examples, comprise data indicating an egress traffic definition associated with egress traffic 404 of one or more application(s) 112(1)-112(N) of the application orchestration system 108. In some examples, the egress traffic 404 may be flowing from the application orchestration system 108 and/or the one or more application(s) 112 to the one or more remote service(s) 406(1)-406(N).

In examples, the network 102 may be a software-defined wide area network (SD-WAN). Although many of the examples described herein are with respect to SD-WAN, other types of network configurations are possible in addition to, or alternatively to, an SD-WAN. For instance, the network 102 may also include a multiprotocol label switching (MPLS) network, a 4G or 5G network, a broadband internet network, a dedicated internet network, or any computer network. In some examples, the network 102 may be associated with one or more edge nodes, such as the edge nodes 408(1), 408(2), and 408(3) that serve different enterprise sites 412. For instance, the edge node 408(1) may be an edge device of the enterprise site 412(1), the edge node 408(2) may be an edge device of the enterprise site 412(2) (e.g., which may be an enterprise data center), and the edge node 408(3) may be an edge device of the enterprise site 412(3) (e.g., which may be an enterprise colocation facility).

In examples, the network orchestrator 104 may be a software-defined networking (SDN) controller that monitors, probes, establishes, etc. flows over the network 102. In some instances, the network orchestrator 104 may be an application in the network 102 architecture that manages flow control for improved network management and application performance. In some examples, the network orchestrator 104 may run on a server and use protocols to tell switches or routers of the network 102 (e.g., the edge nodes 408(1)-408(3) or other devices of the network fabric) where to send packets (e.g., the egress traffic 404). In some examples, the network orchestrator 104 may direct traffic according to one or more forwarding policies defined by a network operator, thereby minimizing manual configurations for individual network devices, such as the edge nodes 408(1)-408(3) or other devices of the network 102 fabric.

In some instances, the network orchestrator 104 may establish different networking paths, such as the networking paths 410(1), 410(2), and 410(3), from the application orchestration system 108 to the remote service(s) 406 that an application 112, or the application orchestration system 108 itself, is consuming. Additionally, in some examples, the edge nodes 408 may probe the different networking path(s) 410 over time and send this information to the network orchestrator 104 to determine which specific path may be the best way for an application 112 (or the orchestration system, generally) to reach the remote service(s) 406. Additionally, in some instances, the network orchestrator 104 may dynamically select specific networking path(s) 410 to send the application egress traffic 404 to the remote service(s) 406.

In examples, the network orchestrator 104 may receive egress traffic information 402 from the application orchestration system 108. In some examples, the egress traffic information 402 may be associated with the individual application(s) 112 hosted on the application orchestration system 108 (e.g., specific egress policies for specific applications), or may be associated with the application orchestration system 108 itself (e.g., a global egress policy for the application orchestration system 108). In some examples, the egress traffic information may include an egress traffic definition associated with the egress traffic 404 of the application(s) 112 and/or the application orchestration system 108. In some examples, the egress traffic definition may be stored in an egress configuration (e.g., configuration file) associated with the application orchestration system 108 or an application 112 (e.g., namespace). The egress traffic definition may include, in some instances, a destination internet protocol (IP) address associated with one of the remote services 406, a destination port associated with one of the remote services 406, a network 5-tuple associated with the egress traffic 404, a hostname or domain name associated with the remote services 406, and/or the like.

In some examples, the egress traffic information 402 may be used by the network orchestrator 104 to determine an optimal networking path 410 to send the egress traffic 404 to the remote service(s) 406. For example, using egress traffic information 402 (e.g., egress traffic definition or configuration) associated with a specific application 112, the network orchestrator 104 may determine which specific remote service 406 that the specific application 112 is sending its egress traffic 404 to, and based on its probing and knowledge of the available networking path(s) 410, the network orchestrator 104 may select a best or most optimal networking path 410 for steering the egress traffic 404 or, in some cases, may establish a new networking path 410 for the egress traffic 404 if an optimal path doesn't exist. In some instances, whether a networking path 410 is optimal can depend on the egress traffic 404 requirements of an application, such as whether the egress traffic 404 needs a high throughput flow, a low latency flow, a high bandwidth flow, or the like. In some examples, the networking path 410 that is optimized for sending the egress traffic 404 to the specific remote service 406 may be a networking path that traverses through a fabric of the network 102, such as the networking path 410(1) that flows through the network 102 from the edge node 408(1) to the edge node 408(2) or the networking path 410(2) that flows through the network 102 from the edge node 408(1) to the edge node 408(3). In another example, the optimal networking path may be a direct internet access path, such as the networking path 410(3) that bypasses the fabric of the network 102 and goes directly to the remote service(s) 406.

In examples, how the network orchestrator 104 receives the egress traffic information 402 associated with the egress traffic 404 may vary depending upon implementation. In some examples, the network orchestrator 104 may establish a connection 116 with the application orchestration system 108. Via the connection 116, the network orchestrator 104 may obtain the egress traffic information 402 on demand from the application orchestration system 108. Additionally, or alternatively, in some examples, an agent 110 may be running on the application orchestration system 108, and the agent 110 may be configured to monitor and/or retrieve egress traffic information 402 data on behalf of the network orchestrator 104, as well as configured to forward the egress traffic information 402 to the network orchestrator 104. As just an example, if a new egress traffic configuration is detected by the agent 110 (e.g., a new application 112 is spun up), if a change in an egress traffic configuration is detected by the agent 110, or in other cases, the agent 110 may forward the egress traffic information 402 associated with that egress traffic configuration to the network orchestrator 104.

In some examples, an operator 416 associated with the application orchestration system 108 and/or on of the applications 112 may associated network metadata 414 with an egress traffic configuration associated with an application 112. In some examples, the network metadata 414 may indicate or prioritize which egress data flows are to be consumed by the network 102 and/or the network orchestrator 104 to determine optimal networking paths. Additionally, or alternatively, the network metadata 414 may be used by the network orchestrator 104 and/or the network 102 to determine which networking path to use for sending the egress flows. In one example, associating the network metadata 414 with the egress traffic configuration may include defining, by the operator 416, an annotation for an egress policy (e.g., security policy) in the egress traffic configuration. In an additional, or alternative, example, if the network 102 includes an SD-WAN, the operator 416 may associate one or more SD-WAN policies (e.g., security policies) with the egress traffic configuration. As another additional, or alternative, example, the operator 416 may associate the network metadata 414 with the egress traffic configuration by storing an indication in a configuration file associated with the application 112 or the application orchestration system 108, and the indication may be indicative of the specific networking path 410 that is optimized for sending the egress traffic 404 to the specific remote service 406. In some examples, the network metadata 414 may indicate egress traffic requirements of an application, such as whether the egress traffic needs a high throughput flow, a low latency flow, a high bandwidth flow, or the like. However, the network metadata 414 and the operator 416 may not be needed according to the techniques described herein, and the system may run without the input.

In some examples, the application orchestration system 108 may be any type of application orchestration system or container orchestration platform (e.g., Kubernetes, Docker Swarm, Apache Mesos, etc.) that is capable of explicitly defining configuration for application egress traffic 404. In some examples, this defined configuration may be a part of the general configuration of the application orchestration system 108 itself (e.g., part of some network policies in Kubernetes), can be an ad-hoc configuration in place to handle the egress traffic 404 (e.g., in-house solutions), can be part of a component running on the application orchestration system 108 that is capable of handling the egress traffic 404 (e.g., a service mesh where explicit egress policies can be defined), and/or the like. In some examples, the application orchestration system 108 infrastructure may be running at the enterprise site 412(1), a cloud-based data center, an enterprise data center, or the like.

In examples, the remote service(s) 406 may be any type of remote service or application that is being utilized by the one or more application(s) 112 and/or the application orchestration system 108. For examples, the remote service(s) 406 may include, among other things, software-as-a-service (SaaS) workloads, application programming interface (API) services, remote storage or database solutions (e.g., key-value stores), middleware services, monolithic services, or the like.

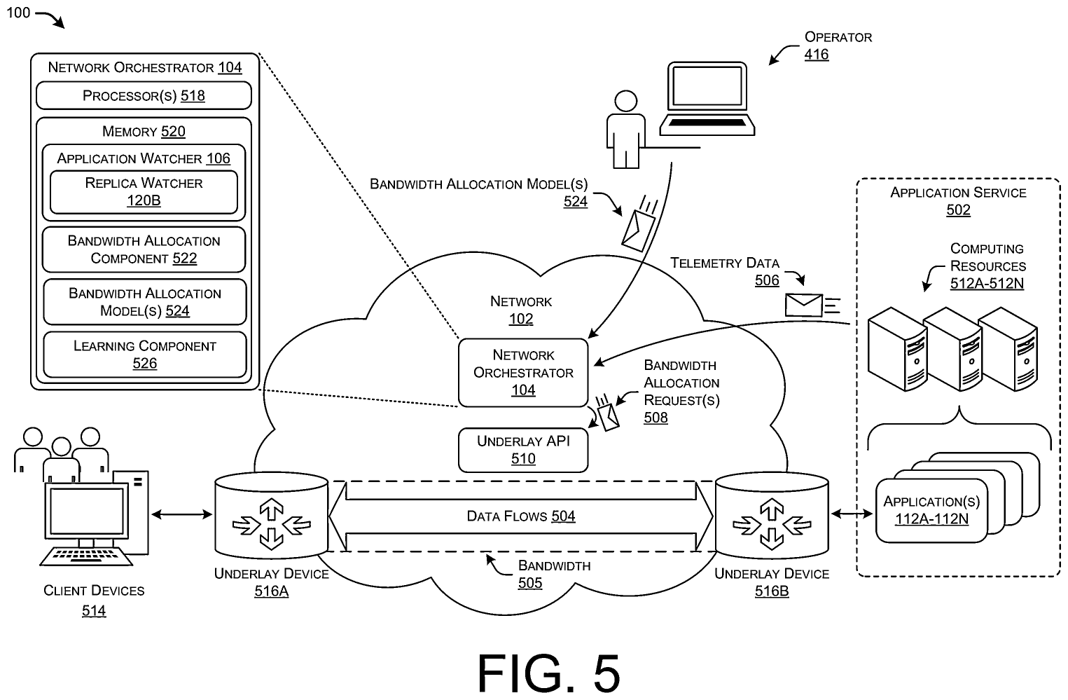

FIG. 5 is an example architecture diagram 500 in which a replica watcher 120B of an application watcher 106 tracks compute capacity of an application 112 to dynamically allocate bandwidth for data flows associated with one or more applications 112A-112N (hereinafter referred to collectively as “applications 112,” and where N represents any number of applications greater than or equal to 1) hosted by an application service 502.

For example, the network orchestrator 104 of the network 102 may receive telemetry data 506 (e.g., indicating an amount of computing resources 512A-512N of the application service 502 that are currently allocated to host the applications 112) from the application service 502 and, based at least in part on the telemetry data 506, the network orchestrator 104 may determine that more or less of the bandwidth 505 is to be allocated or de-allocated. Accordingly, the network orchestrator 104 may send one or more bandwidth allocation requests to an underlay API 510 (e.g., an application programming interface (API) associated with an underlay of the network 102) and, in response, the underlay API 510 may cause more or less bandwidth 505 to be allocated or de-allocated for increased or decreased amounts of the data flows 504 associated with the applications 112. In this way, when applications 112 are replicated by the application service and/or when additional computing resources 512 are being utilized by the applications 112, the bandwidth 505 for the data flows 504 between the client devices 514 and the applications 112 (e.g., using the underlay devices 516A and 516B of the network 102) may more accurately be allocated based on current demand to improve efficiency of the underlay.

In some examples, the network orchestrator 104 may include one or more processors 518 and memory 520 communicatively coupled with the one or more processors 518. In examples, the one or more processors 518 may execute instructions stored in the memory 520 to perform one or more operations on behalf of the network orchestrator 104. The memory 520 of the network orchestrator 104 stores a bandwidth allocation component 522, one or more bandwidth allocation models 524, and a learning component 526.

In at least one example, the bandwidth allocation component 522 may include functionality to analyze the telemetry data 506 received from the application service 502 to determine a current amount of computing resources 512 of the application service 502 that are allocated to host the applications 112. In this way, the bandwidth allocation component 522 may determine whether the bandwidth 505 should be increased or decreased. Additionally, the bandwidth allocation component 522 may access one of the other components of the memory 520 (e.g., the bandwidth allocation models 524 and/or the learning component 526) to determine how much bandwidth to allocate between the underlay devices 516A and 516B.

As noted above, the memory 520 of the network orchestrator 104 may store one or more bandwidth allocation models 524. In some examples, the network orchestrator 104 may receive one or more of the bandwidth allocations models 524 from one or more network operator devices 136 and store the models in the memory 520. In additional, or alternative examples, the bandwidth allocation models 524 may be generated by the network orchestrator 104 (e.g., using the learning component 526). For instance, the learning component 526 may generate the bandwidth allocations models 524 based at least in part on determining associations between prior amounts of bandwidth 505 allocated to serve respective amounts of computing resources 512 allocated for applications 112.

The processors 518 of the network orchestrator 104 may be any suitable processor capable of executing instructions to process data and perform operations as described herein. By way of example and not limitation, the processors 518 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

The memory 520 of the network orchestrator 104 is an example of non-transitory computer-readable media. The memory 520 can store an operating system and one or more software applications, instructions, programs, and/or data to implement the methods described herein and the functions attributed to the various systems. In various implementations, the memory 520 can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

The application service 502 may comprise a cloud-based application service that hosts one or more third-party applications, virtual machines, containers, and the like using infrastructure (e.g., physical devices, such as the computing resources 512) of the cloud-based application service. For instance, the application service 502 may comprise an open-source container-orchestration system as described herein, such as, for example, Kubernetes, Amazon ECS, SaltStack, Cloud Foundry, Rancher, and the like. The one or more computing resources 512 of the application service 502 may be used to host the applications 112. The computing resources 512 may comprise hardware servers, software servers that are running on computer hardware, processors, general purpose computers, and the like.

The network 102 may facilitate the communication of traffic between applications 112 of the application service 502 and client devices 514. The network 102 may comprise an overlay network and an underlay network. The overlay network may comprise a telecommunications network that is built on top of the underlay network and is supported by its infrastructure (e.g., the underlay network's physical devices, such as the underlay devices 516A and 516B). The underlay network may comprise a software-defined/API-driven underlay provider (e.g., PacketFabric, Megaport, PCCW Global's ConsoleConnect, etc.). Accordingly, the network 102 may include the network orchestrator 104 that communicates with the underlay API 510 to instruct the underlay API 510 how much bandwidth should be allocated in the underlay of the network 102. It should be appreciated that, although shown as residing in the same network 102 for simplicity, the network orchestrator 104 may reside in a different network than the underlay API 510 and the underlay devices 516A and 516B. In some instances, the network orchestrator 104 may additionally, or alternatively, reside in a different geographic location than the underlay API 510 and/or the underlay devices 516A and 516B. The underlay devices 516A and 516B of the network 102 may comprise routers, switches, general purpose computers, software nodes, gateways, and/or any other networking device capable of forwarding packets through the network 102.

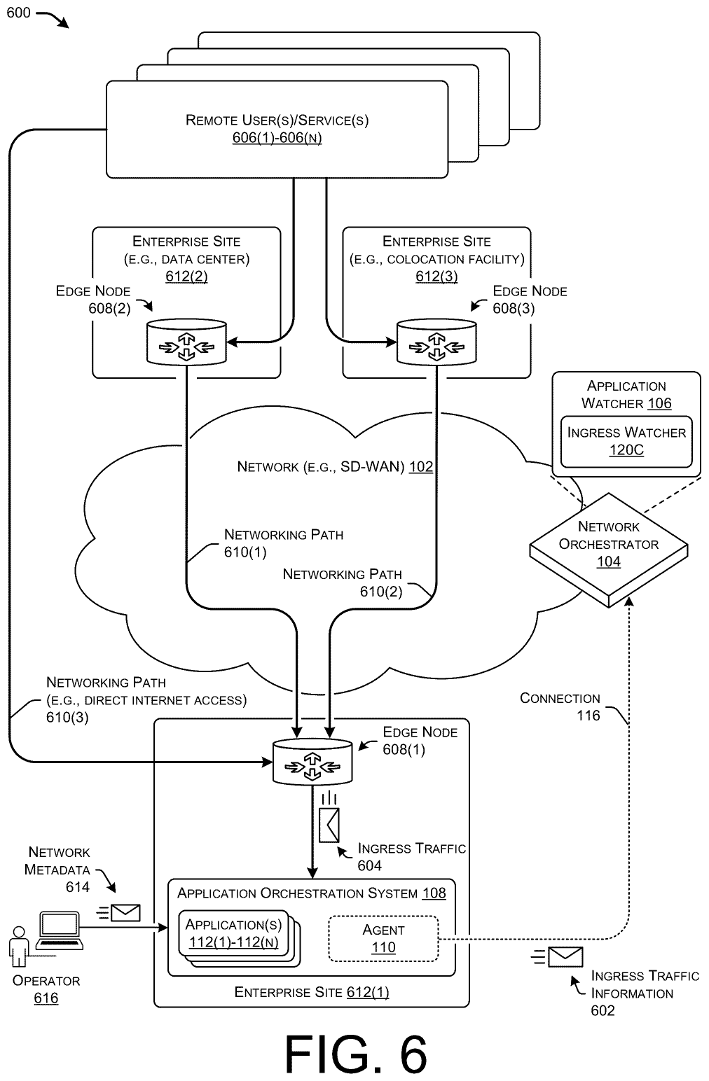

FIG. 6 is an example architecture diagram 600 in which an ingress watcher 120C of an application watcher 106 automates traffic optimizations for ingress traffic 604 of an application orchestration system 108 that is being sent over a network 102 to an application 112.

In some examples, the network orchestrator 104 of the network 102 may receive ingress traffic information 602 (e.g., ingress configuration 126) associated with the application orchestration system 108. Some of the techniques are described herein as being performed by the network orchestrator, 104, but it should be understood that some or all of those techniques may be performed with or by the application watcher 106 and the ingress watcher 120C. The ingress traffic information 602 may, in some examples, comprise data indicating an ingress traffic definition associated with ingress traffic 604 of one or more application(s) 112(1)-112(N) of the application orchestration system 108. In some examples, the ingress traffic 604 may be flowing from one or more remote service(s) 606(1)-606(N) (and/or user devices) to the application orchestration system 108 and/or the one or more application(s) 112.

In examples, the network 102 may be a software-defined wide area network (SD-WAN). Although many of the examples described herein are with respect to SD-WAN, other types of network configurations are possible in addition to, or alternatively to, an SD-WAN. For instance, the network 102 may also include a multiprotocol label switching (MPLS) network, a 4G or 5G network, a broadband internet network, a dedicated internet network, or any computer network. In some examples, the network 102 may be associated with one or more edge nodes, such as the edge nodes 608(1), 608(2), and 608(3) that serve different enterprise sites 612. For instance, the edge node 608(1) may be an edge device of the enterprise site 612(1), the edge node 608(2) may be an edge device of the enterprise site 612(2) (e.g., which may be an enterprise data center), and the edge node 608(3) may be an edge device of the enterprise site 612(3) (e.g., which may be an enterprise colocation facility).

In examples, the network orchestrator 104 may be a software-defined networking (SDN) controller that monitors, probes, establishes, etc. flows over the network 102. In some instances, the network orchestrator 104 may be an application in the network 102 architecture that manages flow control for improved network management and application performance. In some examples, the network orchestrator 104 may run on a server and use protocols to tell switches or routers of the network 102 (e.g., the edge nodes 608(1)-608(3) or other devices of the network fabric) where to send packets (e.g., the ingress traffic 604). In some examples, the network orchestrator 104 may direct traffic according to one or more forwarding policies defined by a network operator, thereby minimizing manual configurations for individual network devices, such as the edge nodes 608(1)-608(3) or other devices of the network 102 fabric.

In some instances, the network orchestrator 104 may establish different networking paths, such as the networking paths 610(1), 610(2), and 610(3), from the application orchestration system 108 to the remote service(s) 606 that an application 112, or the application orchestration system 108 itself, is consuming. Additionally, in some examples, the edge nodes 608 may probe the different networking path(s) 610 over time and send this information to the network orchestrator 104 to determine which specific path may be the best way for remote user/service 606 to reach the application orchestration system 108. Additionally, in some instances, the network orchestrator 104 may dynamically select specific networking path(s) 610 to send the application ingress traffic 604 to the application orchestration system 108.

In examples, the network orchestrator 104 may receive ingress traffic information 602 from the application orchestration system 108. In some examples, the ingress traffic information 602 may be associated with the individual application(s) 112 hosted on the application orchestration system 108 (e.g., specific ingress policies for specific applications) or specific remote users/services 606, or may be associated with the application orchestration system 108 itself (e.g., a global ingress policy for the application orchestration system 108). In some examples, the ingress traffic information may include an ingress traffic definition associated with the ingress traffic 604 of the application(s) 112, the remote users/services 606, and/or the application orchestration system 108. In some examples, the ingress traffic definition may be stored in an ingress configuration (e.g., configuration file) associated with the remote users/services 606, application orchestration system 108, or an application 112 (e.g., namespace). The ingress traffic definition may include, in some instances, a destination internet protocol (IP) address associated with one of the applications 112, a destination port associated with one of the applications 112, a network 5-tuple associated with the ingress traffic 604, a hostname or domain name associated with the remote services 606, and/or the like. Additionally, or alternatively, the ingress traffic definition may include, in some instances, a source internet protocol (IP) address associated with one of the remote users/services 606, a source port associated with one of the remote users/services 606, a network 5-tuple associated with the ingress traffic 604, a hostname or domain name associated with the remote users/services 606, and/or the like.

In some examples, the ingress traffic information 602 may be used by the network orchestrator 104 to determine an optimal networking path 610 to send the ingress traffic 604 to the applications 112. For example, using ingress traffic information 602 (e.g., egress traffic definition or configuration) associated with a specific application 112, the network orchestrator 104 may determine which specific application 112 that the remote user/service 606 is sending its ingress traffic 604 to, and based on its probing and knowledge of the available networking path(s) 610, the network orchestrator 104 may select a best or most optimal networking path 610 for steering the ingress traffic 604 or, in some cases, may establish a new networking path 610 for the ingress traffic 604 if an optimal path doesn't exist. In some instances, whether a networking path 610 is optimal can depend on the ingress traffic 604 requirements of an application, such as whether the ingress traffic 604 needs a high throughput flow, a low latency flow, a high bandwidth flow, or the like. In some examples, the networking path 610 that is optimized for sending the ingress traffic 604 to the specific remote user/service 606 may be a networking path that traverses through a fabric of the network 102, such as the networking path 610(1) that flows through the network 102 from the edge node 608(1) to the edge node 608(2) or the networking path 610(2) that flows through the network 102 from the edge node 608(1) to the edge node 608(3). In another example, the optimal networking path may be a direct internet access path, such as the networking path 610(3) that bypasses the fabric of the network 102 and goes directly to the applications 112.

In examples, how the network orchestrator 104 receives the ingress traffic information 602 associated with the ingress traffic 604 may vary depending upon implementation. In some examples, the network orchestrator 104 may establish a connection 116 with the application orchestration system 108. Via the connection 116, the network orchestrator 104 may obtain the ingress traffic information 602 on demand from the application orchestration system 108. Additionally, or alternatively, in some examples, an agent 110 may be running on the application orchestration system 108, and the agent 110 may be configured to monitor and/or retrieve ingress traffic information 602 data on behalf of the network orchestrator 104, as well as configured to forward the ingress traffic information 602 to the network orchestrator 104. As just an example, if a new egress traffic configuration is detected by the agent 110 (e.g., a new application 112 is spun up), if a change in an egress traffic configuration is detected by the agent 110, or in other cases, the agent 110 may forward the ingress traffic information 602 associated with that egress traffic configuration to the network orchestrator 104.

In some examples, an operator 616 associated with the application orchestration system 108 and/or on of the applications 112 may associated network metadata 614 with an ingress traffic configuration associated with an application 112. In some examples, the network metadata 614 may indicate or prioritize which ingress data flows are to be consumed by the network 102 and/or the network orchestrator 104 to determine optimal networking paths. Additionally, or alternatively, the network metadata 614 may be used by the network orchestrator 104 and/or the network 102 to determine which networking path to use for sending the ingress flows. In one example, associating the network metadata 614 with the ingress traffic configuration may include defining, by the operator 616, an annotation for an ingress policy (e.g., security policy) in the ingress traffic configuration. In an additional, or alternative, example, if the network 102 includes an SD-WAN, the operator 616 may associate one or more SD-WAN policies (e.g., security policies) with the ingress traffic configuration. As another additional, or alternative, example, the operator 616 may associate the network metadata 614 with the ingress traffic configuration by storing an indication in a configuration file associated with the application 112 or the application orchestration system 108, and the indication may be indicative of the specific networking path 610 that is optimized for sending the ingress traffic 604 to the specific applications 112. In some examples, the network metadata 614 may indicate ingress traffic requirements of an application, such as whether the ingress traffic needs a high throughput flow, a low latency flow, a high bandwidth flow, or the like. However, the network metadata 614 and the operator 616 may not be needed according to the techniques described herein, and the system may run without the input.

In some examples, the application orchestration system 108 may be any type of application orchestration system or container orchestration platform (e.g., Kubernetes, Docker Swarm, Apache Mesos, etc.) that is capable of explicitly defining configuration for application ingress traffic 604. In some examples, this defined configuration may be a part of the general configuration of the application orchestration system 108 itself (e.g., part of some network policies in Kubernetes), can be an ad-hoc configuration in place to handle the ingress traffic 604 (e.g., in-house solutions), can be part of a component running on the application orchestration system 108 that is capable of handling the ingress traffic 604 (e.g., a service mesh where explicit ingress policies can be defined), and/or the like. In some examples, the application orchestration system 108 infrastructure may be running at the enterprise site 612(1), a cloud-based data center, an enterprise data center, or the like.

In examples, the remote service(s) 606 may be any type of remote service or application that is being utilized by the one or more application(s) 112 and/or the application orchestration system 108. For examples, the remote service(s) 606 may include, among other things, software-as-a-service (SaaS) workloads, application programming interface (API) services, remote storage or database solutions (e.g., key-value stores), middleware services, monolithic services, or the like.

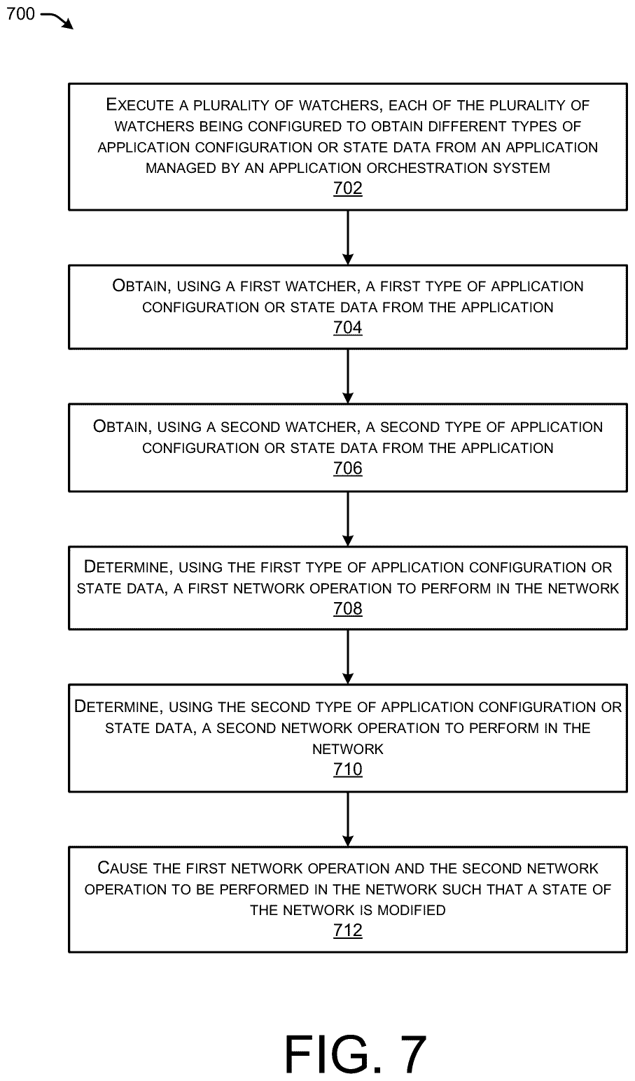

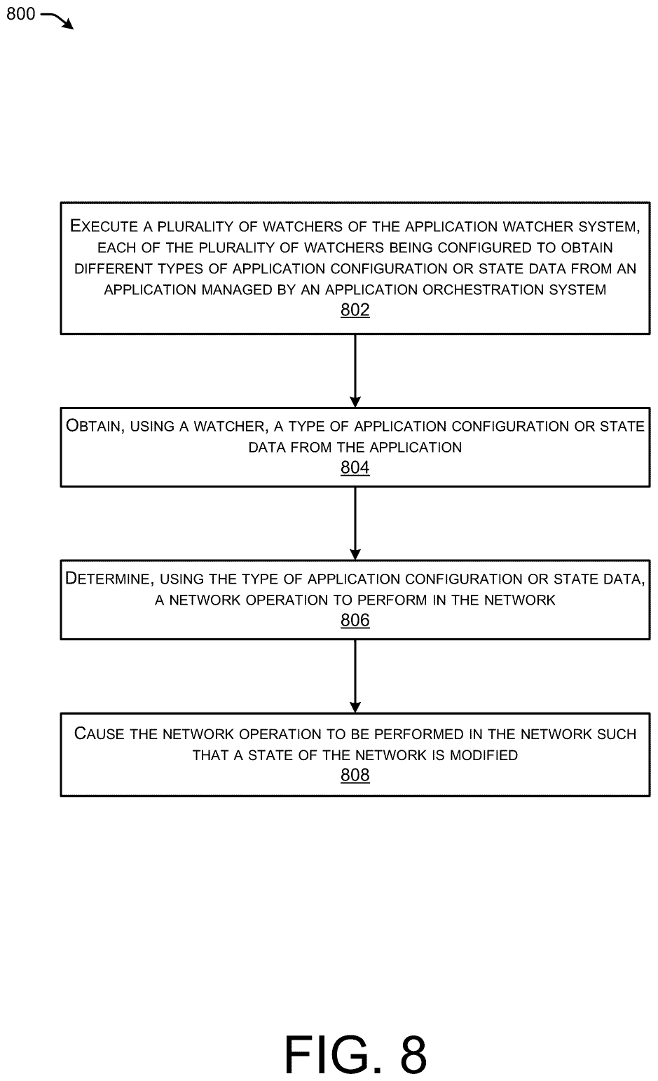

FIGS. 7 and 8 are flow diagrams illustrating an example methods 700 and 800 associated with automating traffic optimizations for egress traffic of an application orchestration system that is being sent over a network to a remote service. The logical operations described herein with respect to FIGS. 6 and 7 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 7 and 8 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 7 is a flow diagram illustrating an example method 800 for multiple application watchers to obtain application configuration or state data that is used to determine network operations.

At 702, an application watcher 106 and/or a network orchestrator 104 may execute a plurality of watchers, wherein each of the plurality of watchers are configured to obtain different types of application configuration or state data from an application managed by an application orchestration system.

At 704, an application watcher 106 and/or a network orchestrator 104 may obtain, using a first watcher, a first type of application configuration or state data from the application.

At 706, an application watcher 106 and/or a network orchestrator 104 may obtain, using a second watcher, a second type of application configuration or state data from the application.

At 708, an application watcher 106 and/or a network orchestrator 104 may determine, using the first type of application configuration or state data, a first network operation to perform in the network.

At 710, an application watcher 106 and/or a network orchestrator 104 may determine, using the second type of application configuration or state data, a second network operation to perform in the network.

At 712, an application watcher 106 and/or a network orchestrator 104 may cause the first network operation and the second network operation to be performed in the network such that a configuration and/or state of the network is modified.

In some examples, the first watcher is an ingress watcher that obtains an ingress traffic definition associated with ingress traffic of the application, and the first type of application configuration or state data is an ingress traffic definition obtained by the ingress watcher and is associated with ingress traffic of the application. In such examples, causing the first network operation to be performed in the network includes causing the ingress traffic to be sent to the application via a networking path of the network that is optimized for sending the ingress traffic to the application. Further, the ingress traffic definition includes at least one of a destination internet protocol (IP) address associated with the application, a destination port associated with the application, a hostname associated with the application, or a uniform resource locator (URL) associated with the application.

In some instances, the first watcher is an encryption watcher that determines whether traffic communicated with the application requires encryption, and the first type of application configuration or state data is an encryption policy for the application indicating that the traffic requires encryption. In such examples, causing the first network operation to be performed in the network includes determining that traffic being communicated to the application is not encrypted, and based on the traffic not being encrypted and on the encryption policy, causing a network device in the network to encrypted the traffic.

In examples, the application orchestration system manages different instances of the application at a first site and a second site that are remote from each other. For these examples, the first watcher may be a capacity watcher that obtains capacity data that indicates available amounts of capacity at the first site and the second site, and the first type of application configuration or state data is the capacity data. Further, determining the first network operation to perform in the network includes determining to route traffic to the first site based on the first site having more available capacity as compared to the second site, and causing the first network operation to be performed in the network includes causing the traffic to be sent to an instance of the application running at the first site.

In some instances, the method 700 may further comprise sending, by a network state propagator of the application watcher system, updated state data to the application orchestration system such that the application orchestration system is apprised of the state of the network being modified.

In some instances, the method 700 may further comprise allocating a first amount of bandwidth of a physical underlay of the network for data flows associated with the application. In such examples, the first watcher is a replica watcher that obtains replica data that indicates a change in an amount of computing resources that are allocated to host the application, and determining the first network operation to perform in the network includes determining, based at least in part on the replica data, a second amount of bandwidth of the physical underlay to allocate for the data flows. Further, in these examples allocating the second amount of bandwidth of the physical underlay of the network for the data flows associated with the application.

FIG. 8 is a flow diagram illustrating an example method 800 for an application watcher 106 (and/or a network orchestrator 104) to obtain application configuration or state data 118 that is used to determine a network operation.

At 802, application watcher 106 and/or a network orchestrator 104 may execute a plurality of watchers of the application watcher system, wherein each of the plurality of watchers are configured to obtain different types of application configuration or state data from an application managed by an application orchestration system.

At 804, application watcher 106 and/or a network orchestrator 104 may obtain, using a watcher, a type of application configuration or state data from the application.

At 806, application watcher 106 and/or a network orchestrator 104 may determining, using the type of application configuration or state data, a network operation to perform in the network.

At 808, application watcher 106 and/or a network orchestrator 104 may cause the network operation to be performed in the network such that a configuration and/or state of the network is modified.

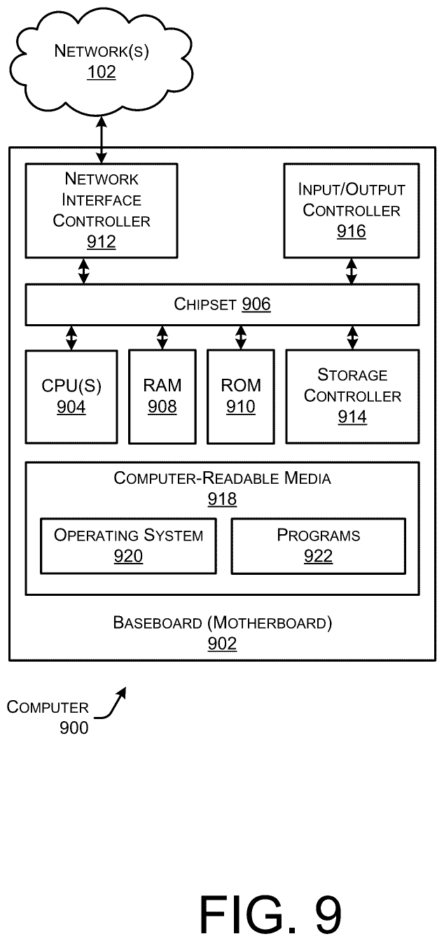

FIG. 9 is a computer architecture diagram showing an illustrative computer hardware architecture for implementing a computing device that can be utilized to implement aspects of the various technologies presented herein. The computer architecture shown in FIG. 9 illustrates a conventional server computer, network node (e.g., secure access node), router, workstation, desktop computer, laptop, tablet, network appliance, e-reader, smartphone, load balancer, or other computing device, and can be utilized to execute any of the software components presented herein.

The computer 900 includes a baseboard 902, or “motherboard,” which is a printed circuit board to which a multitude of components or devices can be connected by way of a system bus or other electrical communication paths. In one illustrative configuration, one or more central processing units (“CPUs”) 904 operate in conjunction with a chipset 906. The CPUs 904 can be standard programmable processors that perform arithmetic and logical operations necessary for the operation of the computer 900.

The CPUs 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 can provide an interface to a RAM 908, used as the main memory in the computer 900. The chipset 906 can further provide an interface to a computer-readable storage medium such as a read-only memory (“ROM”) 910 or non-volatile RAM (“NVRAM”) for storing basic routines that help to startup the computer 900 and to transfer information between the various components and devices. The ROM 910 or NVRAM can also store other software components necessary for the operation of the computer 900 in accordance with the configurations described herein.

The computer 900 can operate in a networked environment using logical connections to remote computing devices and computer systems through a network, such as the network 102, the application orchestration system 108, or the like. The chipset 906 can include functionality for providing network connectivity through a NIC 912, such as a gigabit Ethernet adapter. The NIC 912 is capable of connecting the computer 900 to other computing devices over the network 924. It should be appreciated that multiple NICs 912 can be present in the computer 900, connecting the computer to other types of networks and remote computer systems. In some examples, the NIC 912 may be configured to perform at least some of the techniques described herein.

The computer 900 can be connected to a storage device 918 that provides non-volatile storage for the computer. The storage device 918 can store an operating system 920, programs 922, and data, which have been described in greater detail herein. The storage device 918 can be connected to the computer 900 through a storage controller 914 connected to the chipset 906. The storage device 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 900 can store data on the storage device 918 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 918 is characterized as primary or secondary storage, and the like.

For example, the computer 900 can store information to the storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 900 can further read information from the storage device 918 by detecting the physical states or characteristics of one or more particular locations within the physical storage units.

In addition to the mass storage device 918 described above, the computer 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 900. In some examples, the operations performed by the architecture 100 and or any components included therein, may be supported by one or more devices similar to computer 900. Stated otherwise, some or all of the operations performed by the architecture 100, and or any components included therein, may be performed by one or more computer devices 900 operating in a scalable arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 918 can store an operating system 920 utilized to control the operation of the computer 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 918 can store other system or application programs and data utilized by the computer 900.

In one embodiment, the storage device 918 or other computer-readable storage media is encoded with computer-executable instructions which, when loaded into the computer 900, transform the computer from a general-purpose computing system into a special-purpose computer capable of implementing the embodiments described herein. These computer-executable instructions transform the computer 900 by specifying how the CPUs 904 transition between states, as described above. According to one embodiment, the computer 900 has access to computer-readable storage media storing computer-executable instructions which, when executed by the computer 900, perform the various processes and functionality described above with regard to FIGS. 1-8, and herein. The computer 900 can also include computer-readable storage media having instructions stored thereupon for performing any of the other computer-implemented operations described herein.

The computer 900 can also include one or more input/output controllers 916 for receiving and processing input from a number of input devices, such as a keyboard, a mouse, a touchpad, a touch screen, an electronic stylus, or other type of input device. Similarly, an input/output controller 916 can provide output to a display, such as a computer monitor, a flat-panel display, a digital projector, a printer, or other type of output device. It will be appreciated that the computer 900 might not include all of the components shown in FIG. 9, can include other components that are not explicitly shown in FIG. 9, or might utilize an architecture completely different than that shown in FIG. 9.

The computer 900 may include one or more hardware processors (processors) configured to execute one or more stored instructions. The processor(s) may comprise one or more cores. Further, the computer 900 may include one or more network interfaces configured to provide communications between the computer 900 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 922 may comprise any type of programs or processes to perform the techniques described in this disclosure for automating traffic optimizations for traffic of an application orchestration system that is being sent over a network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A network orchestrator that manages a network and executes an application watcher system, the network orchestrator comprising:
one or more processors; and
one or more non-transitory computer-readable media storing instructions that, when executed by one or more processors, cause the one or more processors to perform operations comprising:
executing a plurality of watchers, wherein each of the plurality of watchers are configured to obtain different types of application configuration or state data from an application managed by an application orchestration system;
obtaining, using a first watcher, a first type of application configuration or state data from the application;
obtaining, using a second watcher, a second type of application configuration or state data from the application;
determining, using the first type of application configuration or state data, a first network operation to perform in the network;
determining, using the second type of application configuration or state data, a second network operation to perform in the network; and
causing the first network operation and the second network operation to be performed in the network such that a configuration or state of the network is modified.

2. The network orchestrator of claim 1, wherein:
the first watcher is an ingress watcher that obtains an ingress traffic definition associated with ingress traffic of the application;
the first type of application configuration or state data is an ingress traffic definition obtained by the ingress watcher and is associated with ingress traffic of the application; and
causing the first network operation to be performed in the network includes causing the ingress traffic to be sent to the application via a networking path of the network that is optimized for sending the ingress traffic to the application.

3. The network orchestrator of claim 2, wherein the ingress traffic definition includes at least one of a destination internet protocol (IP) address associated with the application, a destination port associated with the application, a hostname associated with the application, or a uniform resource locator (URL) associated with the application.

4. The network orchestrator of claim 1, wherein:
the first watcher is an encryption watcher that determines whether traffic communicated with the application requires encryption;
the first type of application configuration or state data is an encryption policy for the application indicating that the traffic requires encryption; and
causing the first network operation to be performed in the network includes:
determining that traffic being communicated to the application is not encrypted; and
based on the traffic not being encrypted and on the encryption policy, causing a network device in the network to encrypted the traffic.

5. The network orchestrator of claim 1, wherein:
the application orchestration system manages different instances of the application at a first site and a second site that are remote from each other;
the first watcher is a capacity watcher that obtains capacity data that indicates available amounts of capacity at the first site and the second site;
the first type of application configuration or state data is the capacity data;
determining the first network operation to perform in the network includes determining to route traffic to the first site based on the first site having more available capacity as compared to the second site; and
causing the first network operation to be performed in the network includes causing the traffic to be sent to an instance of the application running at the first site.

6. The network orchestrator of claim 1, further comprising sending, by a network state propagator of the application watcher system, updated state data to the application orchestration system such that the application orchestration system is apprised of the state of the network being modified.

7. The network orchestrator of claim 1, the operations further comprising:
allocating a first amount of bandwidth of a physical underlay of the network for data flows associated with the application,
wherein:
the first watcher is a replica watcher that obtains replica data that indicates a change in an amount of computing resources that are allocated to host the application;
determining the first network operation to perform in the network includes determining, based at least in part on the replica data, a second amount of bandwidth of the physical underlay to allocate for the data flows; and
allocating the second amount of bandwidth of the physical underlay of the network for the data flows associated with the application.

8. A computer-implemented method for a network orchestrator to manage a network and execute an application watcher system, the method comprising:
executing a plurality of watchers, wherein each of the plurality of watchers are configured to obtain different types of application configuration or state data from an application managed by an application orchestration system;
obtaining, using a first watcher, a first type of application configuration or state data from the application;
obtaining, using a second watcher, a second type of application configuration or state data from the application;
determining, using the first type of application configuration or state data, a first network operation to perform in the network;
determining, using the second type of application configuration or state data, a second network operation to perform in the network; and
causing the first network operation and the second network operation to be performed in the network such that a configuration or state of the network is modified.

9. The computer-implemented method of claim 8, wherein:
the first watcher is an ingress watcher that obtains an ingress traffic definition associated with ingress traffic of the application;
the first type of application configuration or state data is an ingress traffic definition obtained by the ingress watcher and is associated with ingress traffic of the application; and
causing the first network operation to be performed in the network includes causing the ingress traffic to be sent to the application via a networking path of the network that is optimized for sending the ingress traffic to the application.

10. The computer-implemented method of claim 9, wherein the ingress traffic definition includes at least one of a destination internet protocol (IP) address associated with the application, a destination port associated with the application, a hostname associated with the application, or a uniform resource locator (URL) associated with the application.

11. The computer-implemented method of claim 8, wherein:
the first watcher is an encryption watcher that determines whether traffic communicated with the application requires encryption;
the first type of application configuration or state data is an encryption policy for the application indicating that the traffic requires encryption; and
causing the first network operation to be performed in the network includes:
determining that traffic being communicated to the application is not encrypted; and
based on the traffic not being encrypted and on the encryption policy, causing a network device in the network to encrypted the traffic.

12. The computer-implemented method of claim 8, wherein:
the application orchestration system manages different instances of the application at a first site and a second site that are remote from each other;
the first watcher is a capacity watcher that obtains capacity data that indicates available amounts of capacity at the first site and the second site;
the first type of application configuration or state data is the capacity data;
determining the first network operation to perform in the network includes determining to route traffic to the first site based on the first site having more available capacity as compared to the second site; and
causing the first network operation to be performed in the network includes causing the traffic to be sent to an instance of the application running at the first site.

13. The computer-implemented method of claim 8, further comprising sending, by a network state propagator of the application watcher system, updated state data to the application orchestration system such that the application orchestration system is apprised of the state of the network being modified.

14. The computer-implemented method of claim 8, the operations further comprising:
allocating a first amount of bandwidth of a physical underlay of the network for data flows associated with the application,
wherein:
the first watcher is a replica watcher that obtains replica data that indicates a change in an amount of computing resources that are allocated to host the application;
determining the first network operation to perform in the network includes determining, based at least in part on the replica data, a second amount of bandwidth of the physical underlay to allocate for the data flows; and
allocating the second amount of bandwidth of the physical underlay of the network for the data flows associated with the application.

15. A system associated with a network orchestrator that manages a network and executes an application watcher system, the system comprising:
one or more processors; and
one or more non-transitory computer-readable media storing instructions that, when executed by one or more processors, cause the one or more processors to perform operations comprising:
executing a plurality of watchers of the application watcher system, wherein each of the plurality of watchers are configured to obtain different types of application configuration or state data from an application managed by an application orchestration system;
obtaining, using a watcher, a type of application configuration or state data from the application;
determining, using the type of application configuration or state data, a network operation to perform in the network; and
causing the network operation to be performed in the network such that a configuration or state of the network is modified.

16. The system of claim 15, wherein:
the watcher is an ingress watcher that obtains an ingress traffic definition associated with ingress traffic of the application;
the type of application configuration or state data is an ingress traffic definition obtained by the ingress watcher and is associated with ingress traffic of the application; and
causing the network operation to be performed in the network includes causing the ingress traffic to be sent to the application via a networking path of the network that is optimized for sending the ingress traffic to the application.

17. The system of claim 16, wherein the ingress traffic definition includes at least one of a destination internet protocol (IP) address associated with the application, a destination port associated with the application, a hostname associated with the application, or a uniform resource locator (URL) associated with the application.

18. The system of claim 15, wherein:
the watcher is an encryption watcher that determines whether traffic communicated with the application requires encryption;
the type of application configuration or state data is an encryption policy for the application indicating that the traffic requires encryption; and
causing the network operation to be performed in the network includes:
determining that traffic being communicated to the application is not encrypted; and
based on the traffic not being encrypted and on the encryption policy, causing a network device in the network to encrypted the traffic.

19. The system of claim 15, wherein:
the application orchestration system manages different instances of the application at a first site and a second site that are remote from each other;
the watcher is a capacity watcher that obtains capacity data that indicates available amounts of capacity at the first site and the second site;
the type of application configuration or state data is the capacity data;
determining the network operation to perform in the network includes determining to route traffic to the first site based on the first site having more available capacity as compared to the second site; and
causing the network operation to be performed in the network includes causing the traffic to be sent to an instance of the application running at the first site.

20. The system of claim 15, further comprising sending, by a network state propagator of the application watcher system, updated state data to the application orchestration system such that the application orchestration system is apprised of the state of the network being modified.
